(19) United States
(12) Patent Application Publication
(10) Pub. No.: US 2023/0118025 A1
(43) Pub. Date: Apr. 20, 2023

(54) FEDERATED MIXTURE MODELS

(71) Applicant: QUALCOMM Technologies, Inc., San Diego, CA (US)

(72) Inventors: Matthias REISSER, Mountain View, CA (US); Max WELLING, Bussum (NL); Efstratios GAVVES, Amsterdam (NL); Christos LOUIZOS, Amsterdam (NL)

(21) Appl. No.: 17/914,297

(22) PCT Filed: Jun. 3, 2021
(86) PCT No.: PCT/US2021/035809

§ 371 Date: Sep. 23, 2022

(30) Foreign Application Priority Data
Jun. 3, 2020 (GR) 20200100308

(51) Int. Cl. G06N 3/098; G06N 3/045

(52) U.S. Cl. CPC G06N 3/098; G06N 3/045

(57) ABSTRACT

A method of collaboratively training a neural network model, includes receiving a local update from a subset of the multiple users. The local update is related to one or more subsets of a dataset of the neural network model. A local component of the neural network model identifies a subset of the one or more subsets to which a data point belongs. A global update is computed for the neural network model based on the local updates from the subset of the users. The global updates for each portion of the network are aggregated to train the neural network model.

### CROSS REFERENCE TO RELATED APPLICATION

The present application claims priority to Greece Patent Application No. 20200100308, filed on Jun. 3, 2020, and titled “FEDERATED MIXTURE MODELS,” the disclosure of which is expressly incorporated by reference in its entirety.

### FIELD OF THE DISCLOSURE

Aspects of the present disclosure generally relate to neural networks and more particularly to a framework for training a neural network model distributed across multiple users using federated or collaborative learning.

### BACKGROUND

Artificial neural networks may comprise interconnected groups of artificial neurons (e.g., neuron models). The artificial neural network may be a computational device or represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, pattern recognition, speech recognition, autonomous driving, and other classification tasks.

Federated learning is an approach for collaborative training of neural networks across multiple users without gathering data at a central location. One challenge in federated learning is data heterogeneity. That is, it may be difficult to train the neural network using a single global model given that different users may have different data characteristics (e.g., different fauna/flora in different geographies).

### SUMMARY

The present disclosure is set forth in the independent claims, respectively. Some aspects of the disclosure are described in the dependent claims..

In an aspect of the present disclosure, a method is provided. The method includes receiving a local update of the neural network model from a subset of multiple users. Each of the local updates is related to one or more subsets of a dataset and includes an indication of the one or more subsets of the dataset to which each local update relates. The method also includes computing a global update for the neural network model based on the local updates from the subset of the multiple users. Additionally, the method includes transmitting the global update to the subset of the multiple users.

In an aspect of the present disclosure, an apparatus is provided. The apparatus includes a memory and one or more processors coupled to the memory. The processor(s) are configured to receive a local update of the neural network model from a subset of multiple users. Each of the local updates is related to one or more subsets of a dataset and includes an indication of the one or more subsets of the dataset to which each local update relates. The processor(s) are also configured to compute a global update for the neural network model based on the local updates from the subset of the multiple users. In addition, the processor(s) are configured to transmit the global update to the subset of the multiple users.

In an aspect of the present disclosure, an apparatus is provided. The apparatus includes means for receiving a local update of the neural network model from a subset of multiple users. Each of the local updates is related to one or more subsets of a dataset and includes an indication of the one or more subsets of the dataset to which each local update relates. The apparatus also includes means for computing a global update for the neural network model based on the local updates from the subset of the multiple users. Additionally, the apparatus includes means for transmitting the global update to the subset of the multiple users.

In an aspect of the present disclosure, a non-transitory computer readable medium is provided. The computer readable medium has encoded thereon program code. The program code is executed by a processor and includes code to receive a local update of the neural network model from a subset of multiple users. Each of the local updates is related to one or more subsets of a dataset and includes an indication of the one or more subsets of the dataset to which each local update relates. The program code also includes code to compute a global update for the neural network model based on the local updates from the subset of the multiple users. Additionally, the program code includes code to transmit the global update to the subset of the multiple users.

In an aspect of the present disclosure, a method is provided. The method includes receiving a neural network model from a server. The neural network model is collaboratively trainable across multiple clients via a set of specialized neural network models. Each specialized neural network being associated with a subset of a first dataset. The method also includes generating a local dataset including one or more local examples. Additionally, the method includes selecting one or more of the specialized models based on a characteristic associated with the local dataset. Further, the method includes generating a personalized model by fine tuning the neural network model based the selected one or more specialized models and the local dataset.

In an aspect of the present disclosure, an apparatus is provided. The apparatus includes a memory and one or more processors coupled to the memory. The processor(s) are configured to receive a neural network model from a server. The neural network model is collaboratively trainable across multiple clients via a set of specialized neural network models. Each specialized neural network is associated with a subset of a first dataset. The processor(s) are also configured to generate a local dataset including one or more local examples. In addition, the processor(s) are configured to select one or more of the specialized models based in part on a characteristic associated with the local dataset. Further, the processor(s) are configured to generate a personalized model by fine tuning the neural network model based the selected one or more specialized models and the local dataset.

In an aspect of the present disclosure, an apparatus is provided. The apparatus includes means for receiving a neural network model from a server. The neural network model is collaboratively trainable across multiple clients via a set of specialized neural network models. Each specialized neural network is associated with a subset of a first dataset. The apparatus also includes means for generating a local dataset including one or more local examples. Additionally, the apparatus includes means for selecting one or more of the specialized models based in part on a characteristic associated with the local dataset. Further, the apparatus includes means for generating a personalized model by fine tuning the neural network model based the selected one or more specialized models and the local dataset.

In an aspect of the present disclosure, a non-transitory computer readable medium is provided. The computer readable medium has encoded thereon program code. The program code is executed by a processor and includes code to receive a neural network model from a server. The neural network model is collaboratively trainable across multiple clients via a set of specialized neural network models. Each specialized neural network is associated with a subset of a first dataset. The program code also includes code to generate a local dataset including one or more local examples. Additionally, the program code includes code to select one or more of the specialized models based in part on a characteristic associated with the local dataset. Furthermore, the program code includes code to generate a personalized model by fine tuning the neural network model based the selected one or more specialized models and the local dataset.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5 illustrates a listing of example pseudocode, in accordance with aspects of the present disclosure.

FIG. 6 is a flow diagram illustrating a method for collaboratively training a neural network model distributed across multiple users according to aspects of the present disclosure.

FIG. 7 is a flow diagram illustrating a method 600 for generating a personalized neural network model, according to aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Federated learning is an approach for collaborative training of neural networks across multiple users without gathering data at a central location. One challenge in federated learning is data heterogeneity. That is, it may be difficult to train the neural network using a single global model given that different users may have different data characteristics.

Aspects of the present disclosure are directed to collaborative training of the neural network using a mixture model. That is, the neural network may be trained using a framework in which the neural network may include an ensemble or multiple models that are adaptively selected and trained.

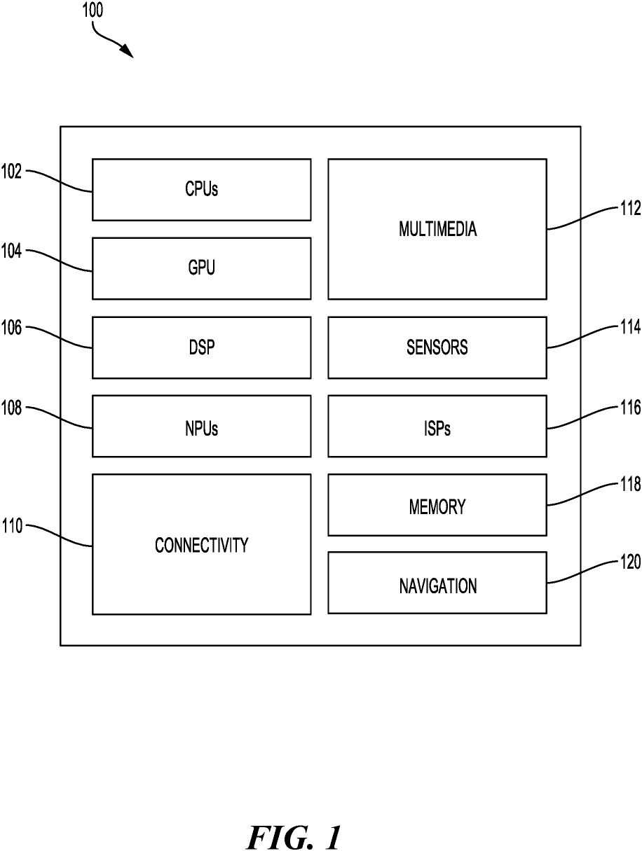

FIG. 1 illustrates an example implementation of a system-on-a-chip (SOC) 100, which may include a central processing unit (CPU) 102 or a multi-core CPU configured to collaboratively train a neural network model distributed across multiple users in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to receive a local update of the neural network model from a subset of the multiple users. each of the local updates being related to one or more subsets of a dataset and includes an indication of the one or more subsets of the dataset to which each local update relates. The instructions loaded into the CPU 102 may also comprise code to computes a global update for the neural network model based on the local updates from the subset of the multiple users. The instructions loaded into the CPU 102 may additionally comprise code to transmit the global update to the subset of the multiple users.

The SOC 100 may be based on an ARM instruction set. In an aspect of the present disclosure, the instructions loaded into the CPU 102 may comprise code to receives a neural network model from a server. The neural network model is collaboratively trainable across multiple clients via a set of specialized neural network models. Each specialized neural network is associated with a subset of a first dataset. The instructions loaded into the CPU 102 may also comprise code to generate a local dataset including one or more local examples. The instructions loaded into the CPU 102 may additionally comprise code to selects one or more of the specialized models based in part on a characteristic associated with the local dataset. The instructions loaded into the CPU 102 may further comprise code to generate a personalized model by fine tuning the neural network model based the selected one or more specialized models and the local dataset.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

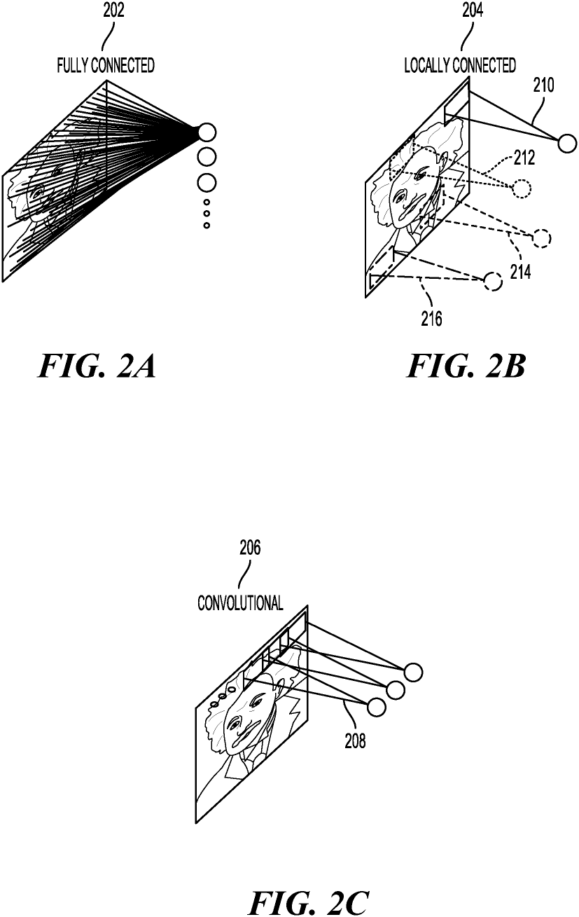

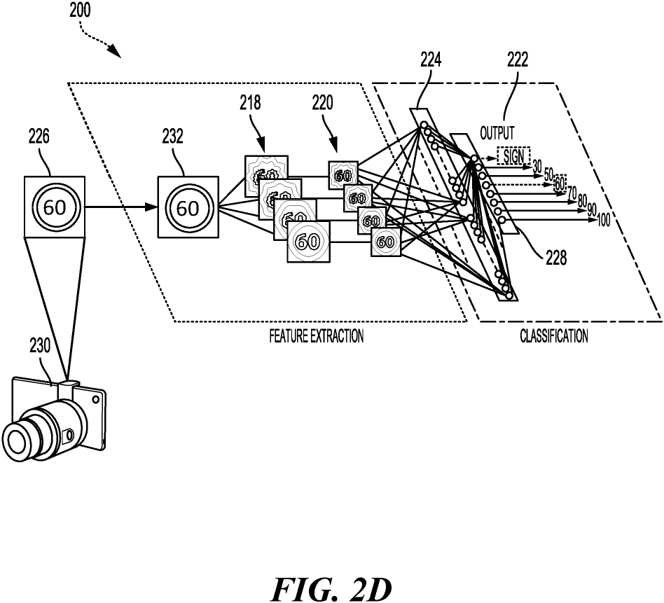

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (e.g., the speed limit sign of the image 226) and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

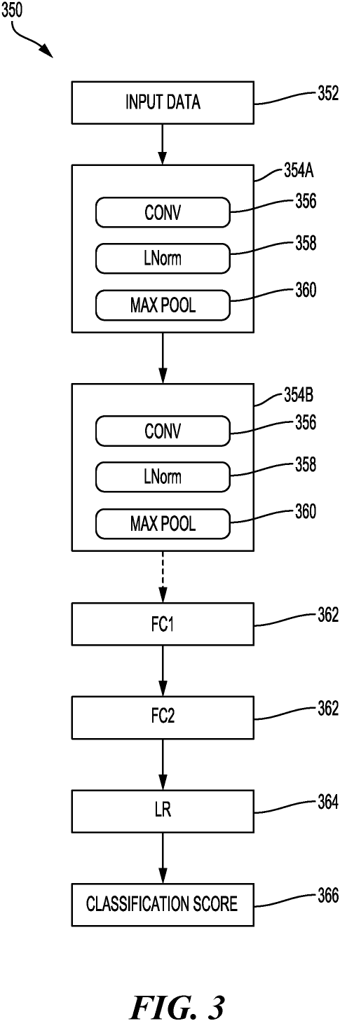

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

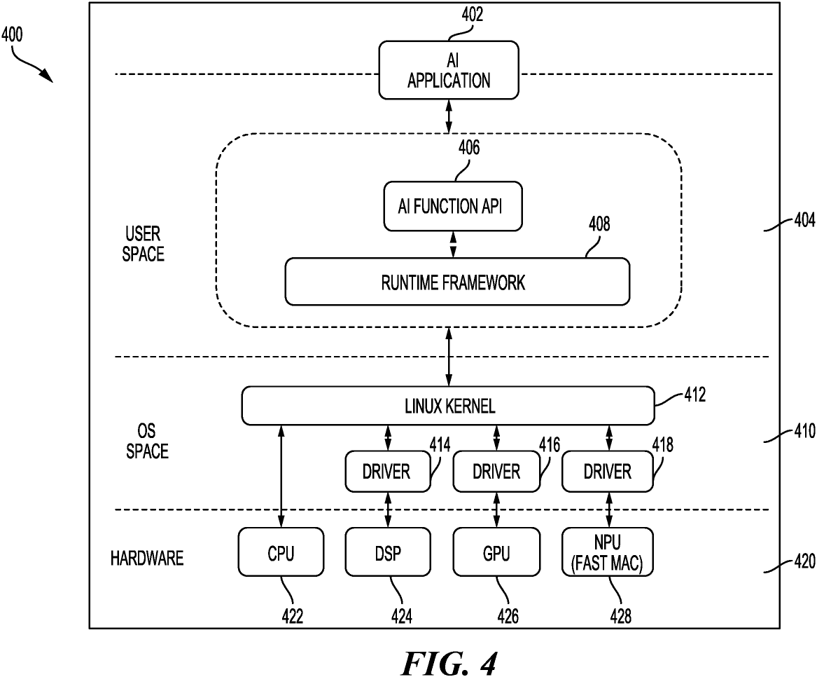

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Linux Kernel 412, running on the SOC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414–342 for a DSP 424, for a GPU 426, or for an NPU 428. In the exemplary example, the differential neural network may be configured to run on a combination of processing blocks, such as a CPU 422 and a GPU 426, or may be run on an NPU 428, if present.

In one aspect, the receiving means, the selecting means, computing means, and/or the training means may be the CPU 102, program memory associated with the CPU 102, the dedicated memory block 118, fully connected layers 362, and or the routing connection processing unit 216 configured to perform the functions recited. In another configuration, the aforementioned means may be any module or any apparatus configured to perform the functions recited by the aforementioned means.

According to certain aspects of the present disclosure, each of the fully connected layers 362 may be configured to determine parameters of the model based upon desired one or more functional features of the model, and develop the one or more functional features towards the desired functional features as the determined parameters are further adapted, tuned and updated.

As indicated above, FIGS. 1-4 are provided as examples. Other examples may differ from what is described with respect to FIGS. 1-4.

As described, federated learning involves collaborative training of neural network models across multiple users, without the need to gather the data at a central location. There are several challenges with federated learning. Federated devices are generally resource constrained, both in computational capacity and communication bandwidth and latency. For instance, a mobile device may suffer reduced performance when transmitting data through a cellular network. Additionally, a mobile device may also have limited heat dissipation capacity, as well as, power and energy constraints.

From a global perspective, devices processing power and network connection may be highly heterogeneous across geographical regions and socioeconomic status of device owners. Users of identical mobile devices generate disparate data due to disparate individual characteristics (e.g., geography). Moreover, users of dissimilar devices may generate even more varied data.

In non-federated machine learning, assuming independent and identically distributed data is generally not detrimental to model performance. In federated learning however, each client performs a series of parameter updates on its own data to amortize the cost of communication. Over time, progress across shards with non-independent and identically distributed data may diverge, which may hinder training progress, significantly slow down convergence, and decrease model performance.

To address these and other issues, the present disclosure is directed to a federated mixture of experts, which allows for training an ensemble of specialized models instead of a single global model. Aspects of the present disclosure aim to address among other things, the non-independent and identically distributed (non-i.i.d.) data nature of the shards of data that may be distributed across devices. In accordance with aspects of the present disclosure, expert models learn to specialize in regions of the input space such that for a given expert, each client’s progress on that expert is aligned. Each client learns which experts are relevant for its shard or portion of the data. A shard is a portion of the dataset. In me aspects of the present disclosure, inference on previously unseen clients may be enabled. Additionally, aspects of the present disclosure are directed to adaptively selecting and training a user-specific selection of ensemble members.

As described, federated learning involves learning a server model with parameters W such as a neural network with a data set of N data points D = {(x₁,y₁), ..., (x_{N},y_{N})} that is distributed across shards S or portions, where, for instance,

$$D = {D}_{1} ∪ ... ∪ {D}_{S}$$

without accessing the shard-specific data sets directly. By defining a loss function

$${L}_{S} \left(D s \text{;} \text{w}\right)$$

per shard, the total risk may be written as:

$$\text{arg} {min}_{w} {\sum }_{s = 1}^{S} \frac{{N}_{s}}{N} {L}_{s} \left({D}_{s} ; \text{w}\right) ,$$

$${L}_{s} \left({D}_{s} ; \text{w}\right) : = \frac{1}{{N}_{s}} {\sum }_{i = 1}^{{N}_{s}} L \left({D}_{s i} ; \text{w}\right)$$

This objective corresponds to empirical risk minimization over the joint data set

$$D$$

with a loss L(·) for each data point. In federated learning, it is beneficial to reduce the communication costs. As such, multiple gradient updates for parameters w in the inner optimization of objective may be performed for each shard S, thus obtaining local models with parameters Wₛ. The multiple gradient updates may be referred to as local epochs such as an amount of data passes through the entire local data set, with an abbreviation of E. Each shard may then communicate data corresponding to the local model Wₛ to the server. In turn, the server updates the global model at round t by averaging the parameters of the local model

$${w}^{t} = {\sum }_{S} \frac{{N}_{S}}{N} {w}_{s}^{t} .$$

This may be referred to as federated averaging.

One challenge in federated learning is that the data are non-independent and identically distributed (non-i.i.d.) across the shards S, that is

$$p \left(\left(D\right| {s}_{i}\right) \neq p \left(\left(D\right| {s}_{j}\right)$$

for i ≠ j. This may make learning a single global model from all of the data with a conventional model problematic. Accordingly, aspects of the present disclosure provide for learning a single global model and learning S individual models.

A mixture of experts may include a set of K experts. Each of the K experts specialized on a region of the input dataset

$$D$$

. A gating function controls selection of an expert for given data point of the input dataset

$$D$$

. Each of the experts may be implemented as a separate, independent artificial neural network, for example. Each of the experts may be trained to determine a prediction for its designated region. Thus the gating function determines for each data point of input dataset

$$D$$

, an expert for determining a prediction for the data point. In some aspects, an expert may be implemented as a separate, independent artificial neural network, for example. A mixture of expert models for data point (x, y) may be described by:

$${p}_{{\text{w}}_{1 : K '} , θ} \left(\left(y\right| \text{x}\right) = {\sum }_{z = 1}^{K} {p}_{{\text{w}}_{z}} \left(\left(y\right| \text{x,} z\right) {p}_{θ} \left(z \left|\text{x}\right)\right) ,$$

where z is a categorical variable that denotes the expert, wₖ are the parameters of the expert k, and θ are the parameters of the gating function.

The mixture of experts may model a dataset where different subsets of the data exhibit different relationships between input x and output y. Rather than training a single global model to fit this relationship at each client throughout the network, each expert k performs on a different subset of the input space. In some aspects, each expert may specialize on a region of the data set D. The gating function models the decision boundary between input regions, assigning data points from subsets of the input region to their respective experts. In the federated setting, subdividing the input region through a mixture of experts may reduce, and in some aspects, alleviate the consequences of non-i.i.d. data by aligning gradient updates across experts.

In some aspects, the federated mixture of experts may be enriched by conditioning the gating function on the shard assignment S (region of the input dataset). The characteristics that make a shard S different from other shards may manifest in learning a different, localized gating function that is not communicated to the server. In selecting K = 1, a standard setting of a federated averaging may be recovered. In selecting K = S, in combination with fixing p(z = s|x, s) = 1, independent models may be recovered. From a global perspective, the following single objective may be maximized:

$$\begin{matrix}{\sum }_{s = 1}^{S} {\sum }_{i = 1}^{{N}_{S}} log {p}_{{\text{w}}_{1 : K} , {θ}_{S}} \left({y}_{s , i} \left|{\text{x}}_{s , i} , s\right)\right) = \\ {\sum }_{s = 1}^{S} {\sum }_{i = 1}^{{N}_{S}} log \left[{\sum }_{z = 1}^{K} p {θ}_{s} \left(z \left|{\text{x}}_{s , i} , s\right)\right) {p}_{{\text{w}}_{z}} \left({y}_{s , i} \left|{\text{x}}_{s , i} , z\right)\right)\right]\end{matrix}$$

Although it is possible to optimize equation 4 directly, in some aspects, a variational lower bound may be formed with a global variational approximation q_{ϕ}(z| ... ) to the true posterior p(z|x, y, s) with parameters ϕ. At test time, p(y|x^{∗}, s) may be evaluated without the variational approximation q. As such, q_{ϕ}(z| ... ) may be conditioned on available side information at training time that may result in improved specialization in the non-i.i.d. federated learning instance. There may be several different reasons for non-i.i.d. data, including for example, label skew, different distributions p(y|s) per shard, input transformations including different p(x| s), and different mappings p(y|x, s), such as label permutations.

In practice, other or additional known sources of misalignment may be included to further improve the approximation, such as a manufacturer identification (ID) for a medical device and a medical scenario, a geographic identifier, or general domain specific information, for instance. Additionally, although a variational approximation q_{ϕ}(z|y), other site information may be used. For example, lower bound may be maximized as follows:

$$\begin{matrix}{\sum }_{s = 1}^{S} {\sum }_{i = 1}^{{N}_{s}} log {p}_{{\text{w}}_{1 : K} , {θ}_{s}} \left({y}_{s , i} \left|{\text{x}}_{s , i}\right) , s\right) \geq {\sum }_{s = 1}^{S} {\sum }_{i = 1}^{{N}_{s}} {E}_{q θ \left(z \left|{y}_{s} , i\right)\right)} \\ \left[log {p}_{{\text{w}}_{z}} \left({y}_{s , i} \left|{\text{x}}_{s , i} , z\right)\right) p {θ}_{s} \left(z \left|{\text{x}}_{s , i} , s\right)\right)\right] + β H \left({q}_{ϕ} \left(z \left|{y}_{s , i}\right)\right)\right) ,\end{matrix}$$

where β is a hyper parameter that controls the entropy of the approximate posterior distribution and E is the expectation function. For example, a low β (e.g., zero) may result in variational approximations q_{ϕ}(z|y) that are more concentrated around a most probable value. On the other hand, higher values of β (e.g., one) may encourage more uncertain distributions.

In some aspects, the parameters in equation 5 may be optimized via gradient descent. However, a closed form update for parameters ϕ based on Lagrange multipliers exists, and each conditional is parameterized directly, for example, as ϕ_{c} = q(z|y = c) ∈ [0,1]^{K}. A solution for the probabilities of each expert K conditioned on a given category c becomes:

$${ϕ}_{c , k} = \frac{{\left({\prod }_{i = 1}^{{N}_{s , c}} \text{} p \left({y}_{s , i} , z = k \left|{\text{x}}_{s , i} , s\right)\right)\right)}^{\frac{1}{{N}_{s , c} β}}}{\sum {}_{z = 1}^{K} {\left({\prod }_{i = 1}^{{N}_{s , c}} \text{} p \left({y}_{s , i} , z = k \left|{\text{x}}_{s , i} , s\right)\right)\right)}^{\frac{1}{{N}_{s , c} β}}}$$

$$= \frac{exp \left(\frac{1}{{N}_{s , c} β}\right) \sum {}_{i = 1}^{{N}_{s , c}} log \text{} p \left({y}_{s , i} , z = k \left|{\text{x}}_{s , i} , s\right)\right)}{\sum {}_{z = 1}^{K} exp \left(\frac{1}{{N}_{s , c} β}\right) \sum {}_{i = 1}^{{N}_{s , c}} log \text{} p \left({y}_{s , i} , z = k \left|{\text{x}}_{s , i} , s\right)\right)}$$

such as, a softmax function, for example, where the logits correspond to the average of the log-joint probabilities of the data points that belong to class y = c and the prior probabilities of expert k in shard S.

In some aspects, expert specialization may be applied. With specialization, the gradients for each expert may be aligned across shards and the training set performance may be improved. However, there may be a trade-off in the mixture of expert formulations in that highly specialized experts may be useful if the local gating networks make correct selections, which may not always be the case for test data. Accordingly, in some aspects, a balance may be struck between specialization of the experts and their robustness to incorrect selection by the gating function. During training, experts initially receive gradients from all data points until q_{ϕ}(z|y) becomes concentrated and enforces specialization. Thus, the speed of specialization may be controlled by tuning the hyper parameter β and performing dampening on the update of the probabilities of q_{ϕ}(z|y).

In some aspects, to avoid prematurely pruning of experts and preserve model capacity, a marginal entropy term in the server H(Eₚ(_{y})[q_{ϕ}(z|y)]) may be included as a regularizer that encourages using all of the experts.

Each of the specialized expert models may include information about the specific subset of the clients that select each particular expert. As such, experts may serve as a starting point for personalization according to data on a specific device. Personalization may be achieved by fine-tuning the models obtained from the server, for example, w_{1:K}, on a client specific training set

$${D}_{s , t r a i n}$$

, thus obtaining

$${w}_{1 : K}^{S} .$$

In some aspects, an approximation that

$$p \left(\left({D}_{t r a i n}\right| S\right) \approx p \left(\left({D}_{t e s t}\right| S\right)$$

may be made where each device has its own data generation function (e.g., a camera or other sensor on a smartphone) such personalized models have improved prediction capabilities on the test data of that particular device. Fine-tuning may be performed by optimizing equation 5 for a small number of epochs (e.g., E = 1) with respect to w_{1:K}, ϕ, and θₛ. Moreover, this fine-tuning may be performed on conventional federated learning methods that involve global parameters shared by all clients.

In a conventional federated learning approach, a central server may select a subset S′ ⊂ {1, ... , S} of clients at time t and transmits a current estimate of the global parameters w^{t} to the clients. Such clients may perform a series of mini-batch gradient updates with the data from their shard Dₛ on a local loss function, which may involve each client moving in possibly different directions in the parameter space. In conventional federated approaches, the server interprets

$${Δ}_{S}^{t} = {w}_{k}^{t} - {w}_{k , s}^{t + 1}$$

as a single step gradient update from client s, averages those gradients, and applies an optimizer to receive w^{t+1}. However, given non-i.i.d. data across clients, the conventional approach may result in slow progress since averaging updates and a highly non-convex parameter space may be suboptimal. On the contrary, in accordance with aspects of the present disclosure, this effect may be mitigated because, for a given expert, the data that is used to update its parameters may be more aligned across shards. In addition, convergence speed may also be improved by modifying the server-side updates. To highlight the distinction, in conventional federated learning approaches, the individual gradients returned by subset S′ of clients are averaged according to the following:

$${Δ}^{t} = {\sum }_{s = 1}^{{S}^{′}} p \left(s\right) ⋅ {Δ}_{s}^{t} , p \left(s\right) = \frac{{N}_{S}}{{N}_{{S}^{′}}}$$

On the other hand, in aspects of the present disclosure, convergence time may be reduced by considering expert specific updates

$${Δ}_{k , s}^{t} = {w}_{k}^{t} - {w}_{k , s}^{t + 1} .$$

The expert specific updates may be supplied to a central server. In turn, the central server may aggregate the expert specific updates to generate a global update. If a client s pruned away, an expert k from his local gating function, the

$${Δ}_{k , s}^{t}$$

becomes zero. The effective magnitude of the resulting update Δₖ may be normalized by up-weighing the updates of all other clients that consider expert k for their local mixture:

$${Δ}_{k}^{t} = {\sum }_{s = 1}^{{S}^{′}} p \left(s \left|z = k\right)\right) ⋅ {Δ}_{k , s}^{t} , p \left(s \left|z = k\right)\right) ∝ p \left(z = k \left|s\right)\right) p \left(s\right)$$

Computing

$$p \left(\left(z\right| s\right) = {E}_{x \sim {D}_{0}} \left[{p}_{{θ}_{S}} \left(\left(z\right| s , x\right)\right]$$

prior to sending updates to the server involves evaluating large neural network models, which may be difficult, where

$$E$$

is the expectation function. As such, p(z|s) may be approximated

$$p \left(\left(z\right| s\right) \approx {q}_{ϕ} \left(\left(z\right| s\right) = {E}_{y \sim {D}_{S}} \left[{q}_{ϕ} \left(\left(z\right| y\right)\right]$$

, which involves a single matrix multiplication.

The update of equation 9 involves access to the marginal q(z|s) = ∑_{y} p(y|s)q_{ϕ}(z|y) at the server. The server also has access to the parameters ϕ used in computing p(zls) before being sent to the server. Thus, q(z|s)may be solved according to q(z|s) = ∑_{y}p(y|s)q_{ϕ}(z|y), with respect to p(y|s) to obtain a marginal label distribution at the client.

In some aspects, the global parameters of an expert are trained using all data points assigned to that expert across all shards to enable learning more robust features. The robustness of the expert’s features may serve as conditions for the gating function rather than training an entirely separate model for p_{θₛ}(x|s). Given a set of intermediary features hₛ(x) of expert k, a local vector πₛ ∈ ℝ^{K},

$$\sum {}_{k}^{K} {π}_{k , s} = 1$$

with which the intermediate features are averaged before applying a linear transformation to compute the input to the softmax gates, which may scale with the number of experts:

$$\begin{matrix}{h}_{s} = \left(\text{x}\right) {\sum }_{\begin{matrix}k = 1 \\ \end{matrix}}^{K} {π}_{k , s} {h}_{k} \left(\text{x}\right) \\ p {θ}_{s} \left(\left(z\right| \text{x} , s\right) = \text{SM} \left({\text{A}}_{s}^{T} {h}_{s} \left(\text{x}\right) + {\text{b}}_{s}\right)\end{matrix}$$

where θₛ = (πₛ, Aₛ, bₛ) are local learnable parameters and SM represents the softmax function.

Three example variances for test time evaluation include the following. In a first example, a client S that participated in training is presented with a new data point (x*,s). Predictions may be done by selecting the value y that maximizes

$$\sum {}_{z = 1}^{K} p \left(y \left|x * , z\right)\right) p \left(z \left|x * , s\right)\right) .$$

In a second example, a new client s* is introduced together with a new labeled local data set D_{s*}. The local gating function may be instantiated and trained by optimizing the parameters θ_{S} of p_{θ_{S}}(z|x, s*) via the local objective. Thereafter, predictions may be made similar to the first example.

In a third example, a new client s* has no labeled data set available. Without a local gating function, ensemble in experts may exhibit random behavior since experts may be overly confident of out of distribution data. Thus, ensemble and may be performed across local gating functions to compute

$$p \left(z \left|x *\right)\right) = \sum {}_{s = 1}^{S} {p}_{{θ}_{s}} \left(z \left|x * , s\right)\right) p \left(s\right) .$$

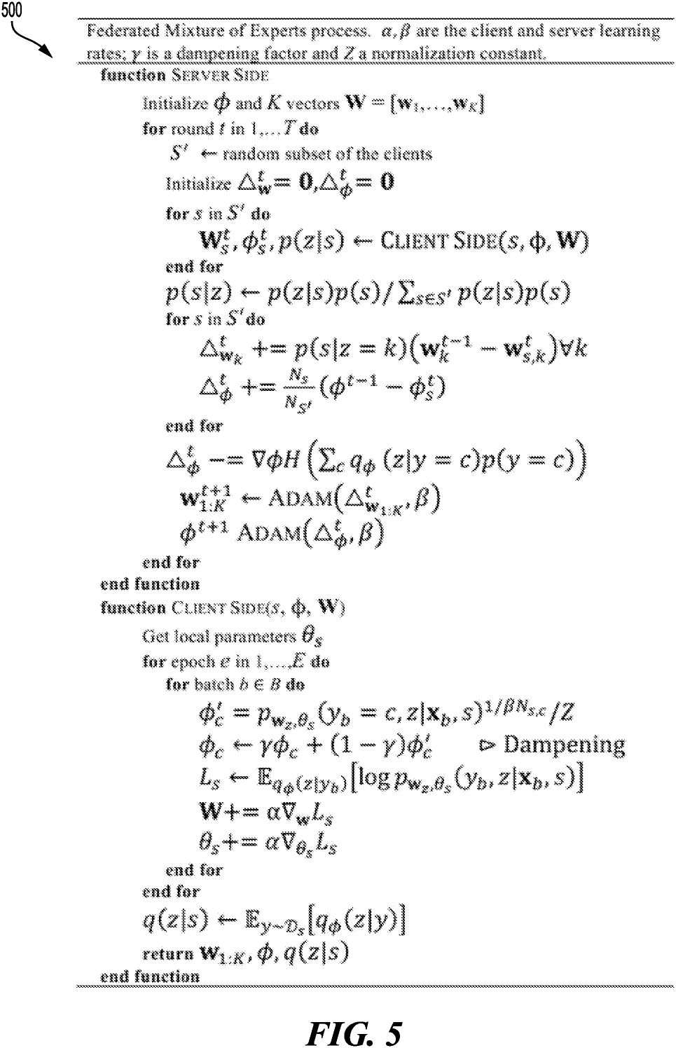

FIG. 5 illustrates a listing of example pseudocode 500, in accordance with aspects of the present disclosure. The example pseudocode 500 describes an example implementation of a system for collaborative learning.

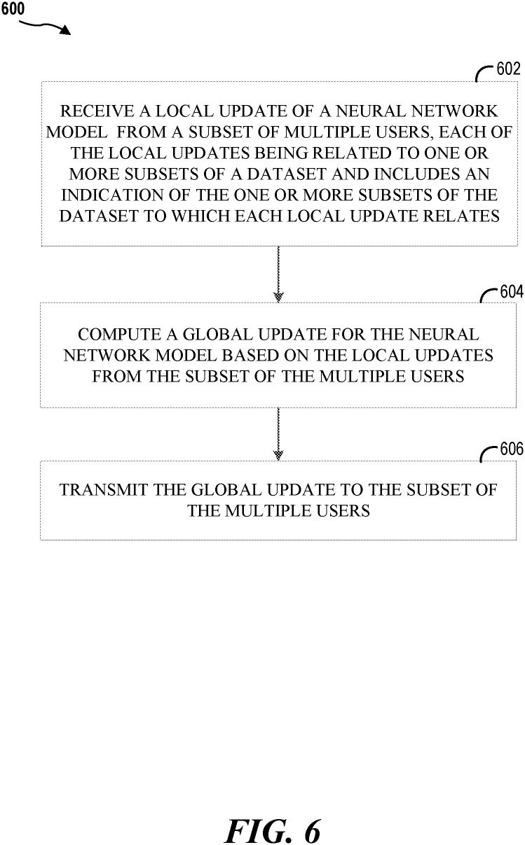

FIG. 6 is a flow diagram illustrating a method 600 of collaboratively training a neural network model distributed across multiple users, according to aspects of the present disclosure. In block 602, the method 600 receives a local update of the neural network model from a subset of the multiple users. Each of the local updates is related to one or more subsets of a dataset and includes an indication of the one or more subsets of the dataset to which each local update relates. As described, instead of learning a single global model, S individual models are learned. A gating function controls selection of an expert for given data point of the input dataset

$$D$$

. Each of the K experts specialized on a region of the input dataset

$$D$$

. Each of the experts may be implemented as a separate, independent artificial neural network, for example. Each of the K experts may correspond to one or more of the S models. Each expert may compute an expert specific updates

$${Δ}_{k , s}^{t} = {w}_{k}^{t} - {w}_{k , s}^{t + 1}$$

for its region of the dataset

$$D$$

. The expert specific updates may be supplied to a central server.

At block 604, the method 600 computes a global update for the neural network model based on the local updates from the subset of the multiple users. In some aspects, the global update is computed by aggregating the local updates received from the subset of the multiple user. In some aspects, the neural network model comprises multiple independent neural network models.

At block 606, the method 600 transmits the global update to the subset of the multiple users. For example, as described, the global parameters of an expert are trained using all data points assigned to that expert across all shards to enable learning more robust features. The robustness of the experts features may serve as conditions for the gating function rather than training an entirely separate model for p_{θₛ}(x|s).

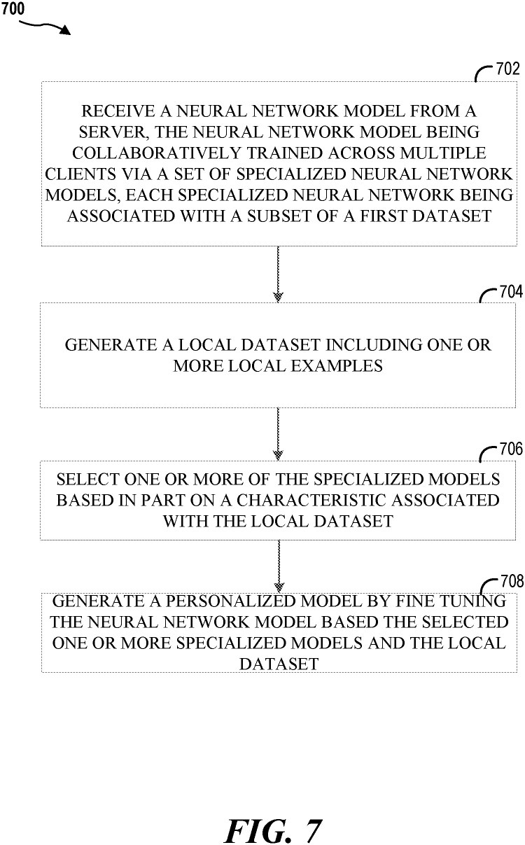

FIG. 7 is a flow diagram illustrating a method 700 for generating a personalized neural network model, according to aspects of the present disclosure. At block 702, the method 700 receives a neural network model from a server. The neural network model is collaboratively trainable across multiple clients via a set of specialized neural network models. Each specialized neural network is associated with a subset of a first dataset. A client or user may receive a neural network model at a local device such as a smartphone, for example. As described, a mixture of experts may model a data set where different subsets of the data exhibit different relationships between input x and output y. Rather than training a single global model to fit this relationship at each client throughout the network, each expert k performs on a different subset of the input space. In some aspects, each expert may specialize on a region of the data set D.

At block 704, the method 700 generates a local dataset including one or more local examples. In some aspects, a local device such as a smartphone may include a data generation function. The data generation function may, for instance include a camera, a microphone, and/or a set of other sensors on a mobile device.

At block 706, the method 700 selects one or more of the specialized models based in part on a characteristic associated with the local dataset. A client or user has a different set of parameters and may select which experts to use based on local data, for example.

At block 708, the method 700 generates a personalized model by fine tuning the neural network model based the selected one or more specialized models and the local dataset. For example, as described, personalization may be achieved by fine-tuning the models obtained from the server, for example, w_{1:K}, on a client specific training set

$${D}_{s , t r a i n}$$

, thus obtaining

$${w}_{1 : K}^{S} .$$

Implementation examples are provided in the following numbered clauses.
1. A method, comprising:
   receiving a local update of the neural network model from a subset of multiple users, each of the local updates being related to one or more subsets of a dataset, and a local component of the neural network model identifies a subset of the dataset to which a data point belongs;
   computing a global update for the neural network model based on the local updates from the subset of the multiple users; and
   transmitting the global update to the subset of the multiple users.
2. The method of clause 1, in which the global update is computed by aggregating the local updates.
3. The method of any of clause 1-2, in which the local component is not communicated with the local updates.
4. The method of any of clause 1-3, in which the neural network model comprises multiple independent neural network models.
5. The method of any of clause 1-4, in which each user of the multiple users has a different mixture of the multiple independent neural network models based on data characteristics for local data.
6. The method of any of clause 1-5, in which the neural network model includes a gating function that models a decision boundary between the one or more subsets and assigns data points to each of the multiple independent neural network models.
7. The method of any of clause 1-6, in which the dataset includes non-independent and identically distributed (non-i.i.d.) data.
8. A method comprising:
   receiving a neural network model from a server, the neural network model being collaboratively trainable across multiple clients via a set of specialized neural network models, each specialized neural network being associated with a subset of a first dataset;
   generating a local dataset including one or more local examples;
   selecting one or more of the specialized models based in part on a characteristic associated with the local dataset; and
   generating a personalized model by fine tuning the neural network model based the selected one or more specialized models and the local dataset.
9. The method of clause 8, further comprising:
   receiving an input; and
   generating an inference via the personalized model based on the input.
10. The method of any of clause 8-9, in which the first dataset comprises non-independent and identically distributed (non-i.i.d.) data.
11. An apparatus, comprising:
   a memory; and
   at least one processor coupled to the memory, the at least one processor being configured:
   to receive a local update of the neural network model from a subset of multiple users, each of the local updates being relevant to one or more subsets of a dataset, and a local component of the neural network model identifies a subset of the dataset to which a data point belongs;
   to compute a global update for the neural network model based on the local updates from the subset of the multiple users; and
   to transmit the global update to the subset of the multiple users.
12. The apparatus of clause 11, in which the at least one processor is further configured to compute the global update by aggregating the local updates.
13. The apparatus of any of clause 11-12, in which the local component is not communicated with the local updates.
14. The apparatus of any of clause 11-13, in which the neural network model comprises multiple independent neural network models.
15. The apparatus of any of clause 11-14, in which each user of the multiple users has a different mixture of the multiple independent neural network models based on data characteristics for local data.
16. The apparatus of any of clause 11-15, in which the neural network model includes a gating function that models a decision boundary between the one or more subsets and assigns data points to each of the multiple independent neural network models.
17. The apparatus of any of clause 11-16, in which the dataset includes non-independent and identically distributed (non-i.i.d.) data.
18. An apparatus comprising:
   a memory; and
   at least one processor coupled to the memory, the at least one processor being configured:
   to receive a neural network model from a server, the neural network model being collaboratively trainable across multiple clients via a set of specialized neural network models, each specialized neural network being associated with a subset of a first dataset;
   to generate a local dataset including one or more local examples;
   to select one or more of the specialized models based in part on a characteristic associated with the local dataset; and
   to generate a personalized model by fine tuning the neural network model based the selected one or more specialized models and the local dataset.
19. The apparatus of clause 18, in which the at least one processor is further configured:
   to receiving an input; and
   to generate an inference via the personalized model based on the input.
20. The apparatus of clause 18 or 19, in which the first dataset comprises non-independent and identically distributed (non-i.i.d.) data.
21. An apparatus, comprising:
   means for receiving a local update of the neural network model from a subset of multiple users, each of the local updates being related to one or more subsets of a dataset and includes an indication of the one or more subsets of the dataset to which each local update relates;
   means for computing a global update for the neural network model based on the local updates from the subset of the multiple users; and
   means for transmitting the global update to the subset of the multiple users.
22. The apparatus of clause 21, further comprising means for computing the global update by aggregating the local updates.
23. The apparatus of clause 21 or 22, in which the local component is not communicated with the local updates.
24. The apparatus of any of clause 21-23, in which the neural network model comprises multiple independent neural network models.
25. The apparatus of any of clause 21-24, in which each user of the multiple users has a different mixture of the multiple independent neural network models based on data characteristics for local data.
26. The apparatus of any of clause 21-25, in which the neural network model includes a gating function that models a decision boundary between the one or more subsets and assigns data points to each of the multiple independent neural network models.
27. The apparatus of any of clause 21-26, in which the dataset includes non-independent and identically distributed (non-i.i.d.) data.
28. A apparatus comprising:
   means for receiving a neural network model from a server, the neural network model being collaboratively trainable across multiple clients via a set of specialized neural network models, each specialized neural network being associated with a subset of a first dataset;
   means for generating a local dataset including one or more local examples;
   means for selecting one or more of the specialized models based in part on a characteristic associated with the local dataset; and
   means for generating a personalized model by fine tuning the neural network model based the selected one or more specialized models and the local dataset.
29. The apparatus of clause 28, further comprising:
   receiving an input; and
   generating an inference via the personalized model based on the input.
30. The method of clause 28 or 29, in which the first dataset comprises non-independent and identically distributed (non-i.i.d.) data.
31. A non-transitory computer readable medium having encoded thereon program code, the program code being executed by a processor and comprising:
   program code to receive a local update of the neural network model from a subset of multiple users, each of the local updates being related to one or more subsets of a dataset and includes an indication of the one or more subsets of the dataset to which each local update relates;
   program code to compute a global update for the neural network model based on the local updates from the subset of the multiple users; and
   program code to transmit the global update to the subset of the multiple users.
32. The non-transitory computer readable medium of clause 31, further comprising program code to compute the global update by aggregating the local updates.
33. The non-transitory computer readable medium of clause 31 or 32, in which a local component is not communicated with the local updates.
34. The non-transitory computer readable medium of any of clause 31-33, in which the neural network model comprises multiple independent neural network models.
35. The non-transitory computer readable medium of any of clause 31-34, in which each user of the multiple users has a different mixture of the multiple independent neural network models based on data characteristics for local data.
36. The non-transitory computer readable medium of any of clause 31-35, further comprising program code to implement a gating function that models a decision boundary between the one or more subsets and assigns data points to each of the multiple independent neural network models.
37. The non-transitory computer readable medium of any of clause 31-36, in which the dataset includes non-independent and identically distributed (non-i.i.d.) data.
38. A non-transitory computer readable medium having encoded thereon program code, the program code being executed by a processor and comprising:
   program code to receive a neural network model from a server, the neural network model being collaboratively trainable across multiple clients via a set of specialized neural network models, each specialized neural network being associated with a subset of a first dataset;
   program code to generate a local dataset including one or more local examples;
   program code to select one or more of the specialized models based in part on a characteristic associated with the local dataset; and
   program code to generate a personalized model by fine tuning the neural network model based the selected one or more specialized models and the local dataset.
39. The non-transitory computer readable medium of clause 38, in which the at least one processor is further configured:
   program code to receiving an input; and
   program code to generate an inference via the personalized model based on the input.
40. The non-transitory computer readable medium of clause 38 or 39, in which the first dataset comprises non-independent and identically distributed (non-i.i.d.) data.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method comprising:
receiving a neural network model from a server, the neural network model being collaboratively trainable across multiple clients via a set of specialized neural network models, each specialized neural network being associated with a subset of a first dataset;
generating a local dataset including one or more local examples;
selecting one or more of the specialized models based in part on a characteristic associated with the local dataset; and
generating a personalized model by fine tuning the neural network model based the selected one or more specialized models and the local dataset.

2. The method of claim 1, further comprising:
receiving an input; and
generating an inference via the personalized model based on the input.

3. The method of claim 2, in which the first dataset comprises non-independent and identically distributed (non-i.i.d.) data.

4. A method, comprising:
receiving a local update of the neural network model from a subset of multiple users, each of the local updates being related to one or more subsets of a dataset and includes an indication of the one or more subsets of the dataset to which each local update relates;
computing a global update for the neural network model based on the local updates from the subset of the multiple users; and
transmitting the global update to the subset of the multiple users.

5. The method of claim 4, in which the global update is computed by aggregating the local updates.

6. The method of claim 4, in which the neural network model comprises multiple independent neural network models.

7. The method of claim 6, in which each user of the multiple users has a different mixture of the multiple independent neural network models based on data characteristics for local data.

8. The method of claim 4, in which the neural network model includes a gating function that models a decision boundary between the one or more subsets and assigns data points to each of the multiple independent neural network models.

9. The method of claim 4, in which the dataset includes non-independent and identically distributed (non-i.i.d.) data.

10. An apparatus comprising:
a memory; and
at least one processor coupled to the memory, the at least one processor being configured:
to receive a neural network model from a server, the neural network model being collaboratively trainable across multiple clients via a set of specialized neural network models, each specialized neural network being associated with a subset of a first dataset;
to generate a local dataset including one or more local examples;
to select one or more of the specialized models based in part on a characteristic associated with the local dataset; and
to generate a personalized model by fine tuning the neural network model based the selected one or more specialized models and the local dataset.

11. The apparatus of claim 10, in which the at least one processor is further configured:
to receiving an input; and
to generate an inference via the personalized model based on the input.

12. The apparatus of claim 11, in which the first dataset comprises non-independent and identically distributed (non-i.i.d.) data.

13. An apparatus, comprising:
a memory; and
at least one processor coupled to the memory, the at least one processor being configured:
to receive a local update of the neural network model from a subset of multiple users, each of the local updates being related to one or more subsets of a dataset and includes an indication of the one or more subsets of the dataset to which each local update relates;
to compute a global update for the neural network model based on the local updates from the subset of the multiple users; and
to transmit the global update to the subset of the multiple users.

14. The apparatus of claim 13, in which the at least one processor is further configured to compute the global update by aggregating the local updates.

15. The apparatus of claim 13, in which the neural network model comprises multiple independent neural network models.

16. The apparatus of claim 13, in which each user of the multiple users has a different mixture of the multiple independent neural network models based on data characteristics for local data.

17. The apparatus of claim 13, in which the neural network model includes a gating function that models a decision boundary between the one or more subsets and assigns data points to each of the multiple independent neural network models.

18. The apparatus of claim 13, in which the dataset includes non-independent and identically distributed (non-i.i.d.) data.
